(19) United States
(12) Patent Application Publication
(10) Pub. No.: US 2004/0035792 A1
(43) Pub. Date: Feb. 26, 2004

(54) Device and method for separating undisolved constituents out of biological fluids

(76) Inventors: Peter R Rauch, Nottuln (DE); Andreas Katerkamp, Munster (DE); Marco Schmitz, Steinfurt (DE); Frank Grawe, Ochtrup (DE)

Correspondence Address: MCGARRY BAIR PC, 171 MONROE AVENUE, N.W., SUITE 600, GRAND RAPIDS, MI, 49503, US

(21) Appl. No.: 10/380,186

(22) PCT Filed: Sep. 5, 2001
(86) PCT No.: PCT/DE01/03517

(30) Foreign Application Priority Data
Sep. 8, 2000 (DE) 100 46 173.5

(51) Int. Cl. B01D 11/00

(52) U.S. Cl. 210/644; 210/649; 210/656; 210/321.84; 210/198.2

(57) ABSTRACT

The invention relates to a device and a method for separating undissolved constituents out of biological fluids, especially for separating blood plasma out of whole blood. It is to propose a simple and cost-effective way by means of which undissolved constituents can be separated out of biological fluids, in particular blood plasma out of whole blood, and the pure fluid is presenting then as a pure liquid volume without any substrate. To solve this object, e.g., whole blood is placed into a feed chamber. The feed chamber is isolated in an all-over manner by means of a membrane from a per se closed cavity having a small height. The cavity is connected to a flow channel or an opening from which the/the separated blood plasma can be removed. The whole blood as a pure biological fluid, which has been placed into a feed chamber (1), will be transferred in the orthogonal direction by means of suction forces, forces of pressure, capillary forces and/or the hydrostatic pressure of the liquid column through the membrane (2) separating the biological fluid from undissolved constituents, from the membrane (2) into a cavity (3) having a small height, and therefrom as a pure fluid into a volume. In the cavity (3) another transport membrane (5) carrying the biological fluid laterally to the flow channel (4) or the opening with a higher effect of capillary force than that of the exclusively separating membrane (2) can be arranged and contacted in a two-dimensional manner with the separating membrane (1).

The invention relates to a device and a method for separating undissolved constituents out of biological fluids, in particular, for the separation of blood plasma out of whole blood. It is allowed to implement the separation of cellular constituents out of cell culture overhangs, however, in order to merely obtain cytoplasm containing dissolved constituents. Further examples of biological fluids are blood serum, urine and liquor or other body fluids such that pure fluids relieved of undissolved constituents can be provided with the invention e.g., for analyzing purposes.

The invention is particularly suitable for laboratory medicine diagnostics. On that occasion, relatively low quantities of biological fluid, e.g. blood plasma, which are largely relieved of interfering components are required for analysis purposes. Such interfering components are cellular constituents, in particular, such as leucocytes and erythrocytes, for example.

An adequately pure blood plasma can be employed with different known diagnosis methods such as e.g. the so-called immuno assays.

Usually, the separation of blood plasma from whole blood is carried out by centrifuging which is particularly expensive and cost intensive.

With immuno chromatographic quick tests, separation membranes are used as a standard when, e.g. whole blood is utilized as a sample fluid. Then, the separated blood plasma generally remains within the membrane material, however, and will not be present as a pure fluid without any substrate, which makes the quantitative analysis impossible in most cases.

Furthermore, from EP 0 336 483 B1 it is known to employ a two part assembly of a hydrophilic micropore type separating membrane and a hydrophilic micropore type collecting membrane, for such purposes. Then, with such a separating membrane the haemacrotit and blood plasma will be separated first, and the separated blood plasma will be collected in the collecting membrane. The collecting membrane containing blood plasma will be subsequently separated from the separating membrane, and the analysis of components of blood plasma will be carried out with the collecting membrane wherein problems are involved during handling and determined analysis methods, in particular quantitative analysis methods wherein a measurement will carried out in a pure fluid volume and will not carried out within a membrane, cannot be readily used without any further treatment.

From EP 0 785 012 A1 it is known to perform a separation by means of an all filtration. With this, one glass fibre membrane and one microporous membrane are used which the blood plasma is passed through, and the interfering cell components are extracted by filtering. With such a filtration, however, the micropores of the membrane are clogging very quickly caused by the erythrocytes, in particular. The time required for the separation is relatively long since it is only allowed to be worked, if any, with small pressure gradients between both sides of the filter membranes in order to avoid a haemolysis of the blood cells and a pollution of the separated blood plasma, respectively.

It is an object of the invention to propose a simple and cost-effective way by means of which undissolved constituents can be separated from biological fluids, in particular blood plasma out of whole blood, and thereafter the biological fluid is present as a pure fluid volume without any substrate.

According to the invention this object is solved with a device comprising the features of any one of claims 1 or 7, and a method according to any one of claims 30 to 32. Advantageous embodiments and improvements can be achieved with the features mentioned in the subordinate claims.

In the following, reference will be exclusively made to whole blood as an example for a biological fluid, from which blood plasma relieved of undissolved constituents is to be separated wherein, needless to say, it is also allowed to analogously proceed with other biological fluids.

With the solution according to the invention, e.g. whole blood is introduced into a feed chamber with the addition of coagulation inhibiting means, as the case may be. The feed chamber is separated from a per se closed cavity having a small height in an all-over manner and snugly fitting using one membrane. The cavity is connected to a flow channel or an opening from which/which the separated blood plasma can be removed.

With the separating membrane the separation is taking place completely or almost completely according to a chromatographic principle wherein the constituents of the fluid and the whole blood, respectively, are carried with different velocities through the membrane, and the blood plasma is flowing more quickly than the cellular constituents contained in the whole blood through the membrane, for example. The, the direction of motion is orthogonally to the actual membrane plane of this membrane.

Since the blood plasma is passed more quickly through the membrane, it is allowed to flow towards a successive flow channel or an opening by means of the advantageously tapering area of the cavity formed on the other membrane side, and to be removed or collected therein, and to be subsequently delivered as a pure fluid volume for an analysis. The tapering area of the cavity is advantageously located outside of the area covered by the separating membrane.

Since the blood plasma is congregating within the membrane on the side of the membrane facing toward the cavity having a small height and is held therein by capillary forces, thus equivalent forces have to act by means of which the blood plasma is passed out of the membrane. This may be suction forces, forces of pressure and capillary forces or the hydrostatic pressure acting through the introduced sample of whole blood, wherein a combination of several of these forces and pressures are also applicable. A hydrostatic pressure is acting due to the liquid column above the separating membrane.

On that occasion, form and dimensioning of the cavity are playing an advantageous role, in particular its small height being uniform across the whole surface which should be smaller than 1 mm, be preferably in the range of 0.01 to 0.5 mm, and be especially preferred at about 0.05 mm.

The wall and the bottom of the cavity, in particular, can be provided with textural elements in a contoured manner which is supporting or enabling the fluid penetrating out of the exclusively separating membrane by means of capillary forces. Thus, profiles can be formed which are acting as capillaries and which canalize the flow of fluid.

The individual channels of a cavity structured in this manner should have free cross-sections for the fluid transport under consideration of the surface energies, which ensure an effect of capillary force being higher than the actual separating membrane.

The surfaces of such channels can also be coated in order to influence the surface tension and therefore the surface energy as well under consideration of the desired higher capillary forces.

The separation, transport and/or drawing off the blood plasma from the device can also take place with the support of suction forces or forces of pressure wherein this may also be the case with the alternative embodiment of the invention which is described in the following.

However, it is also possible to employ a second further membrane by means of which a lateral transport of the blood plasma is achieved within this transport membrane to the opening and the flow channel, respectively. This transport membrane can be inserted into the cavity having a small height and, should fill it up in an all-over manner, if possible, and be in contact with the surface of the bottom side of the exclusively separating membrane. This transport membrane is selected such that it achieves an effect of capillary force higher than the membrane exclusively used for the separation such that the blood plasma from the separating membrane is allowed to passed into the transport membrane by means of an increase of capillary force, and will be carried within this transport membrane laterally and thus orthogonally to the direction of separation.

With the selection of an appropriate membrane material, this transport membrane cannot be used for the fluid transfer only, however, in addition it is also allowed to separate undesired components in a selective manner addition, if possible, which still have been remained as the case may be.

However, the device according to the invention can also be formed in an alternative such that merely one transport membrane is located at least in the cavity having a small height between a feed chamber for the fluid from which the undissolved constituents are to be separated and a flow channel or an opening by means of which the appropriately separated fluid can be transferred into a volume, wherein the transport membrane achieves the transport function for the respective fluid as well as separates the undissolved constituents out of the fluid. On that occasion, with such a transport membrane the fluid at least due to its own effect of capillary force is carried starting from the feed chamber through the transport membrane towards the flow channel and an opening, respectively. The undissolved constituents will be chromatographically separated by means of this transport membrane such that fluid relieved of undissolved constituents can be removed from the flow channel or opening. On that occasion, the time required for the separation and the liquid volume are determined by the characteristics of the material of the transport membrane, the lateral length thereof, the thickness of the transport membrane and the height of the cavity having a small height, respectively. These parameters can be additionally influenced by applied forces of pressure and/or suction forces.

A device according to the invention thus formed is applicable in particular for the preparation of relatively small liquid volumes in the range of some few microlitres (μl) relieved of undissolved constituents.

The time and the achievable liquid volume per time unit can also be influenced in that incisions which are limited in its length and do not extend beyond the total length of the transport membrane, however, can be formed at the end of the transport membrane which faces towards the low channel or opening in parallel to the flow direction of the fluid, thus in the lateral direction.

With the so far described aspect of a device according to the invention wherein merely such a transport membrane is to be used, the fluid to be separated is passed from the feed chamber over the end surface of the transport membrane facing towards the feed chamber for the lateral transport and the separation into the transport membrane.

However, it is also possible to contour and to dimension the transport membrane such that it fills up in an all-over manner both the cavity having a small height and the total surface of the feed chamber. In this case, the fluid to be separated is passed over the free surface of the transport membrane, in the area of the feed chamber into the transport membrane, and is carried therefrom in the lateral direction toward the flow channel or opening within the transport membrane through the cavity having a small height. On that occasion, the velocity of the undissolved constituents within the transport membrane is smaller such that pure fluid is allowed to enter and discharge, respectively, into the flow channel and at the opening or can be transferred into a volume over a certain time interval.

Otherwise, a thus designed example of a device according to the invention can be formed as this has already been described first and will also be described in the following, respectively.

Appropriate membranes for the chromatographic separation of blood plasma are multi-layer, e.g. three-layer polyester membranes as being available from the Prall Company under the trade name of “Hemasep V”.

For the transport membrane optionally located in the cavity such membranes are allowed to be used which effect the transfer of blood plasma by means of capillary forces. For this, fibre membranes made of natural and synthetic fibres can be used. Then, a membrane has been proven to be particularly suitable which is available from the Prall Company as well under the trade name “CytoSep 1660 or 1661”, in particular in combination with the exclusively separating membrane “Hemasep V”. With this type and the membrane types “CytoSep 1660, 1662, 1663 or Hemasep L” it is also allowed to continue separating during the lateral transport.

However, pure transport membranes such as, e.g., nylon membranes (nylon 6,6), cellulose membranes, nitrocellulose membranes, polyether sulfone membranes, borosilicate membranes and glass fibre membranes can also be used which achieve a reduced yield of blood plasma or a less purity degree of the blood plasma, however.

The blood plasma separated by the first membrane isolating the feed chamber and the cavity is situated at the bottom of this membrane and can be transferred therefrom into a volume by means of acting capillary forces due to the shape and the height and, as the case may be with the support of the further transport membrane located within the transport membrane by means of hydrostatic forces.

Thus, a quantity or blood plasma being sufficient for analyses as a rule can be achieved within a time interval of 10 and more minutes.

However, the separation time required can be significantly reduced as suction forces and/or forces of pressure are used in addition. In this case, the time interval for the separation should not be greater than 10 min, if possible, in order to ensure that pure blood plasma is available within the volume.

However, a suction force can also be utilized by applying a negative pressure. With this, a piston and cylinder unit, e.g., a conventional syringe can be joined at the opening or the exit of a flow channel. By an adequate motion of the piston within the cylinder a suction force is applied both to the cavity and the bottom side of the actual separating membrane by means of which the required time can be reduced to a few minutes. The pure separated blood plasma can be received immediately within the cylinder and can be carried with the cylinder to a location of analysis.

However, a force of pressure can also be exerted by itself or additionally on the respective sample which has been inserted into the feed chamber to temporally reduce separating. On that occasion, a plunger or piston can be placed upon the surface of liquid and is allowed to press against the sample liquid and membrane surface with the gravitational force or with accessory forces, as the case may be. The same effect can also be achieved with a compressed gas, preferably an inert gas, however, which will be pressed into the feed chamber closed after charging. On that occasion, the total membrane surface within the feed chamber should be covered with sample fluid (whole blood).

However, the feed chamber being open per se on one side can also be occluded after charging with the sample with a flexible material, e.g., a foil, and the desired force of pressure acting vertically upon the surface of the membrane can be applied by simply pressing by hand due to the achieved reduction of volume.

The cavity having a small height which is located between the actual separating membrane and the opening or the flow channel represents an interface between these elements and serves to carry the separated blood plasma into an appropriate volume.

As a rule, on such a gap shaped cavity a taper towards an opening and the flow channel, respectively, will be formed. However, it is also conceivable to form two diametrically opposing tapering areas or a plurality of tapering areas being arranged such as in a star-like manner on the cavity, which are running into flow channels or openings and communicating with the cavity having a small height. Thus the separation time can be reduced and/or the quantity of blood plasma can be increased.

The cavity having a small height should be transferred directly into a volume by the separated liquid up to the area of the feed chamber and the opening, or should be occluded in a fluid-tight manner in the area of the opening communicating with a flow channel and an opening, respectively, formed in a transport membrane, and separated liquid is transferred into a volume through the flow channel in order to avoid fluid from undesired escaping, and to selectively direct the flow of fluid toward the openings.

However, in each case the relatively great available surface of the separating membrane which separates the feed chamber and cavity has always an advantageous effect in this sense.

With this invention the time required for the separation can be shortened. An equivalent device is simply constructed und fabricable in a low cost manner. It is allowed to be used very simply. The separation is carefully achieved, and the blood plasma is largely pure, is available as a liquid phase without any interfering membrane material, and thus being suitable for the most different methods of analysis.

### In the following, the invention will be explained in more detail according to an example wherein

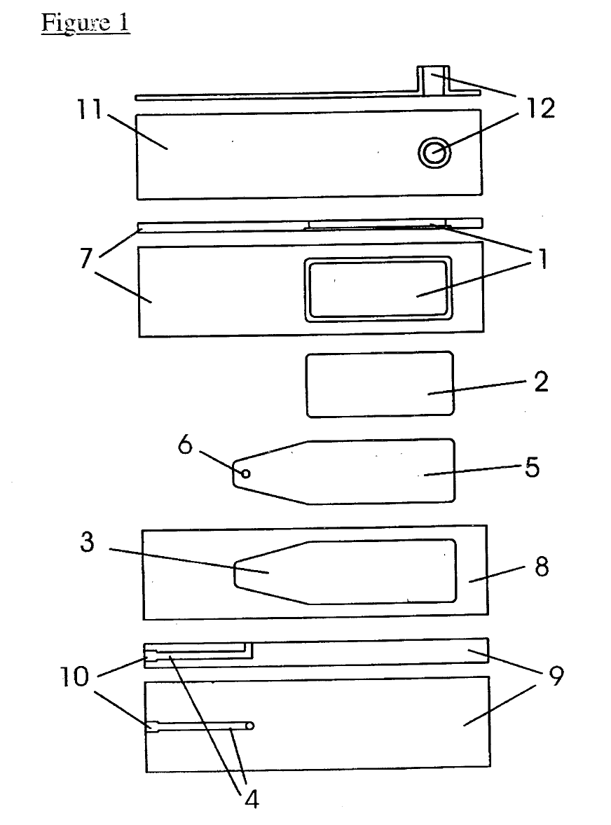

FIG. 1 shows an example of a device according to the invention in a component drawing;

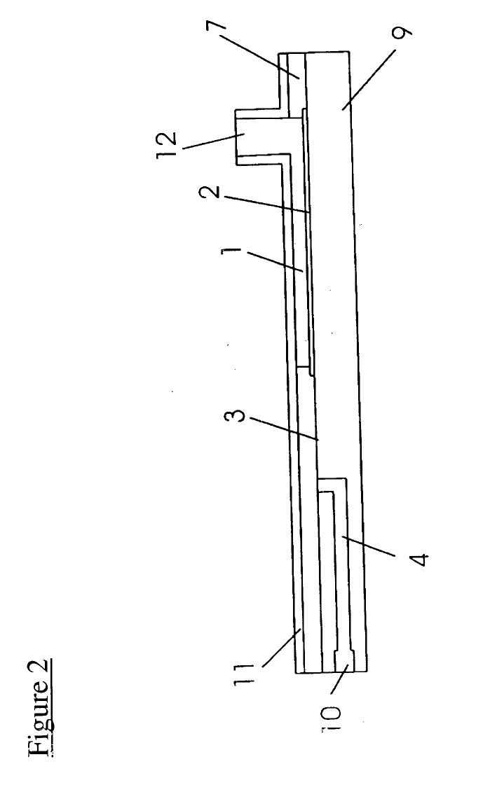

FIG. 2 shows a sectional side view of the example according to FIG. 1;

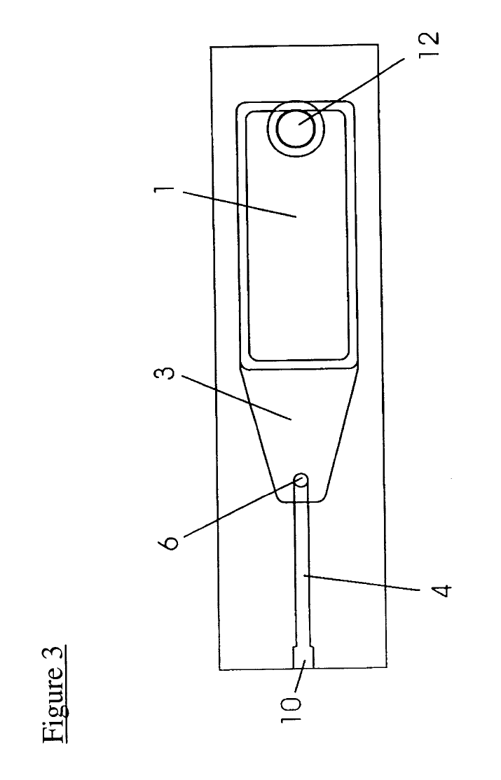

FIG. 3 shows a top view upon the example of a device according to the invention;

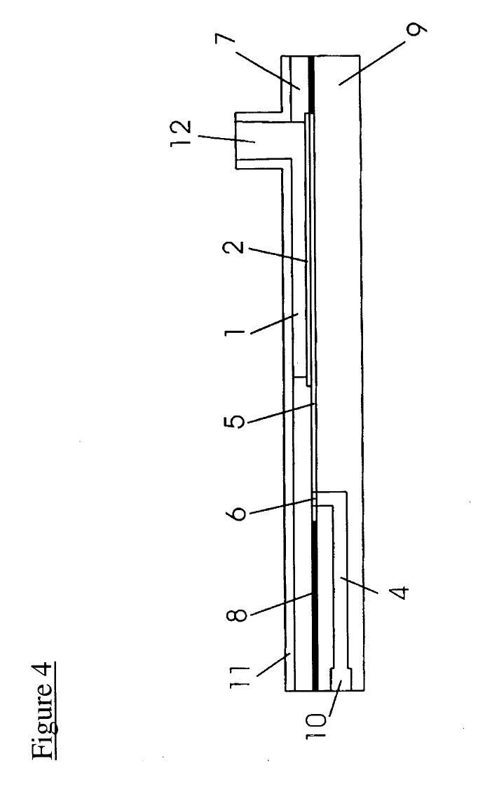

FIG. 4 shows a sectional side view of a device having an auxiliary transport membrane; and

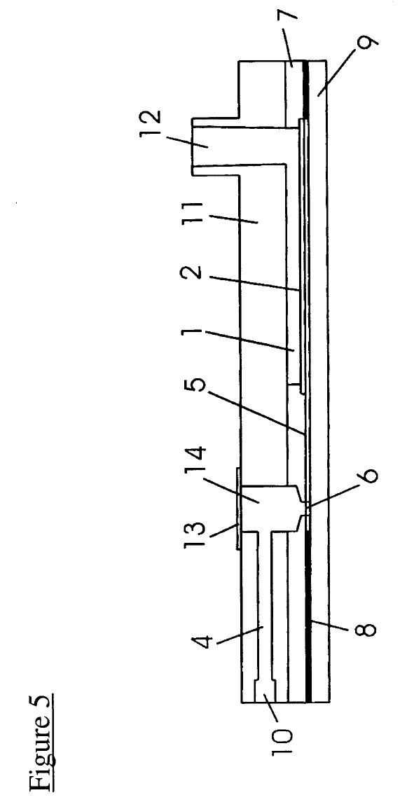

FIG. 5 shows an example of a device having an intermediate container.

The subsequently described example of a device according to the invention is constructed in a relatively simple manner and can be cost-effectively manufactured from a few injection moulding parts of plastic.

In FIG. 1 the individual elements used in this example are shown in a detail drawing.

Herein, the cover portion 7 is used with an opening forming a feed chamber 1, wherein the thickness of the cover portion 7 and the exposed cross-section surface of the opening predetermine the volume in the feed chamber 1 provided for the sample fluid.

This example of a device according to the invention is downwardly formed with a base portion 9. The cover portion 7 and base portion 9 will be coupled with each other before using. The two portions may be glued, welded or connected with each other in a form-fit or friction-fit manner by means of clips, for example.

They can be manufactured from plastic with injection moulding method, however, and are allowed to be composed of other materials as well.

The cavity 3 having a small height tapering in its width can be formed by means of an equivalent recess in a surface of the cover portion 7 or base portion 9 which are facing to each other.

However, with the example shown in the FIGS. 1 to 3 an adhesive film 8 is used which will be coupled with the cover portion 7 and base portion 9, and is forming the one sided wedge-shaped, tapering cavity 3 having a small height by means of a stamped portion. The adhesive film 8 used herein has a thickness of 0.13 mm and predetermines the height of the cavity.

The cavity 3 is dimensioned in a plane manner such that the cross-section surface of the feed chamber 1 is completely covered, and in addition a tapering portion is followed which is not covered by the membrane 2.

The membrane 2 is inserted into the feed chamber 1 for the separation of the blood plasma such that a liquid sample can be placed upon the surface of the membrane 2 into the feed chamber 1 without sample fluid is unseparatedly passing into the cavity 3.

The membrane 2 used with this example is a “Hemasep V” type membrane having a length of 30 mm, a width of 13 mm and a thickness of 0.89±0.05 mm.

With this example, an auxiliary transport membrane 5 is used which fills up in an all-over manner the cavity 3. In this example this transport membrane 5 has a length of 45 mm and a width of 13 mm as well. The smallest widths of the transport membrane 5 and cavity 3 within the tapered area are 5 mm with an angle of the taper of appr. 15°.

In the base portion 9 a flow channel 4 is formed which can be abandoned as well, as the case may, be through which the separated blood plasma is guided toward the opening 10. The blood plasma which at least is carried laterally through the transport membrane 5 is passed through an opening, which is located in the tapering area of the cavity 3 having a small height, into the flow channel 4 and can be drawn off therein. An opening 6 which communicates with the inlet opening of the flow channel 4 is formed in the transport membrane 5.

The separated blood plasma within the transport membrane 5 is accumulating around this opening 6 and allowed to be drawn off there into an appropriate volume by acting forces of pressure or suction forces. Thus, a suction force is allowed to act across the opening 10 in order to achieve this. Because of the small dimensions of the opening small forces are required correspondingly. A suction force is acting upon the relative small inner marginal surface of the opening 6 formed within the transport membrane 5 which is dominantly determined by the thickness of the transport membrane 5.

A hollow needle of a syringe formed correspondingly is allowed to be fixed to the opening 10 of the flow channel 4, and the blood plasma separated thus in a suction force supported manner can be drawn into the cylinder.

The transport membrane 5 can be formed from a material mentioned in the general part of the description.

For the separation of blood plasma a whole blood sample of appr. 500 microlitres (μl) which an anticoagulating substance can be added to is allowed to be placed from above into the open feed chamber 1 upon the surface of the membrane 2.

The whole blood is vertically passed through the membrane 2 oriented horizontally here, wherein the hydrostatic forces for accelerating the blood plasma separation which is achieved using chromatographic effects of the membrane 2, have a time-shortening effect. The blood plasma passing quickly through the membrane with respect to the erythrocytes and other cellular constituents contained in the whole blood is received from the bottom side of the membrane 2 by the transport membrane 5 which capillary forces are greater and is laterally flowing with the support of capillary forces in the direction of the tapering area, and consequently toward the opening of the flow channel 4. There, it is allowed to be removed with the mentioned syringe using a suction force.

With the described arrangement it is allowed to obtain appr. 50 μl of blood plasma from the whole blood sample of 500 μl in appr. 5 min.

The feed chamber 1 can be covered with a cover 11, and the fluid can be placed through the opening 12 formed within the cover 11 into the feed chamber 1. As a result, spilling of sample fluid can be avoided.

With such a design a force of pressure can be exerted across the opening 12. With this, e.g., as an example of a piston and cylinder unit, a syringe drawn up with air can be introduced into the opening 12 and positioned therein. With moving the piston air is pressed into the feed chamber 1 above the sample fluid, and a force of pressure is exerted.

With the sectional view according to FIG. 4, in particular, the arrangement of a transport membrane 5 within the cavity 3 having a small height shall be explained, wherein with the transport membrane 5 used here it can be achieved an additional separating function for undissolved constituents in addition to the effect of its inherent capillary force effect.

To support the separation, it may be generated either a suction force at the opening 10 or a force of pressure at the opening 12 by positioning a piston and cylinder unit to at least one of the openings 10 or 12. Then, with such a piston and cylinder unit a relative motion between the piston and cylinder can be carried out in a continuous form, in an intermittent motion with at least two steps or a motion restricted by an end stopper, and as a result the suction force and the force of pressure can be generated correspondingly.

With such an arrangement, the separation of blood plasma out of whole blood is allowed to be carried out with the support of a suction force and/or force of pressure within a time interval of maximum 10 minutes, wherein with a quantity of whole blood of 550 μl, for example, which is heparinized with Saarstedt type monovettes, a yield of plasma of up to 20% can be achieved.

With the example of a device according to the invention shown in a sectional view of FIG. 5 an auxiliary intermediate container 14 for separated fluid is connected to the cavity 3 having a small height, wherein with this example a transport membrane 5 can be used again in addition to the separating membrane 2. The inlet opening for the biological fluid relieved of undissolved constituents into the intermediate container 14 is located at the opening 6 formed in the transport membrane 5.

The intermediate container 14 has an opening through which the separated fluid can be removed from the fluid relieved of undissolved constituents with a pipette or a conventional syringe having a hollow needle such as for carrying out subsequent analyses.

The intermediate container 14 should be temporally occluded outwardly with at least a fluid-tight cover 13. Such a cover 13 may be a foil, for example, which is circumferentially provided with a bonding agent in a marginal area, and thus may be glued upon the cover and a cover portion 7, respectively, for temporally occluding the opening of the intermediate container 14.

In case, if the intermediate container 14 does not comprise any further connection to the environment and the separation is carried out with a support of force of pressure, it is favourable admittedly to form this cover in a fluid-tight manner, but permeable to gas.

However, in the form shown in FIG. 5 this is not necessarily required since the intermediate container 14 is connected to the flow channel 4, and an opening 10 is provided on the flow channel 4. With such a design, it may additionally separated as well with the support of suction force as this has been already explained with the other examples and in the general part of the description.

To avoid entering and discharging the fluid already separated out of the intermediate container 14 through the flow channel 4 and the opening 10, the inlet opening of the flow channel 4 can be arranged on the intermediate container 14 such that the level of the separated fluid does not reach the inlet opening of the flow channel 4. Another alternative to prevent this effect is to use a membrane being fluid-tight and permeable to gas which can be located at the inlet opening or inside of the flow channel 4.

However, in addition to the use of a foil as cover 13 for the opening of the intermediate container 14 a cap can also be used which is fixable in a friction-fit manner or a form-fit manner and made of plastic material, for example, and which can be pressed simply into the opening.

Such a cap may be replaced again in relatively simple manner for removing separated fluid out of the intermediate container 14, or it is further possible for the cap as a cover 13 to be pierced with a hollow needle of a conventional syringe and thus to draw off the separated fluid out of the intermediate container 14 which also applies logically to the use of a foil as a cover 13.

1. A device for separating undissolved constituents out of biological fluids characterized in that
a feed chamber (1) for the fluid and a cavity (3) having a small height which is connected to a flow channel (4) or an opening are separated by means of a two-dimensional membrane (2) separating the undissolved constituents which the biological fluid is passed through in the orthogonal direction into said cavity (3) having a small height.

2. A device according to claim 1, characterized in that said cavity (3) having a small height is formed in a tapering manner towards said connected flow channel (4) or said opening.

3. A device according to claim 1 or claim 2, characterized in that said tapering area of said cavity (3) having a small height which is connected to said flow channel (4) or said opening is located outwardly of the area covered by said separating membrane (2).

4. A device according to any one of claims 1 to 3 characterized in that said membrane (2) is separating due to chromatographic effects.

5. A device according to any one of claims 1 to 4, characterized in that within said cavity (3) having a small height another transport membrane (5) is located and brought into contact in a two-dimensional manner with said separating membrane (2) which transports said biological fluid in the lateral direction towards said flow channel (4) or said opening and has a higher effect of capillary force than that of said exclusively separating membrane (2).

6. A device according to any one of claims 1 to 5, characterized in that said separating membrane (2) isolating said feed chamber (1) and said cavity (3) having a small height is a multi-layer polymer membrane.

7. A device for separating undissolved constituents out of biological fluids, characterized in that
said cavity (3) having a small height is located between said feed chamber (1) for said fluid and said flow channel (4) or said opening, and said transport membrane (5) separating and carrying said undissolved constituents toward said flow channel (4) or said opening is located at least within said cavity (3).

8. A device according to claim 7, characterized in that said cavity (3) having a small height is formed in a tapering manner towards said connected flow channel (4) or said opening.

9. A device according to claim 7 or claim 8, characterized in that said separating transport membrane (5) fills up in a two-dimensional manner said cavity (3) and the area of said feed chamber (1).

10. A device according to any one of claims 1 to 9, characterized in that said transport membrane (5) is made of a material separating undissolved constituents in the lateral transport direction out of said biological fluid.

11. A device according to any one of claims 1 to 10 characterized in that said transport membrane (5) located within said cavity (3) having a small height fills up said cavity (3) perfectly fitting and is adapted to the shape of said cavity (3).

12. A device according to any one of claims 1 to 11 characterized in that within said transport membrane (5) an opening (6) is formed around said flow channel (4) or said further opening.

13. A device according to any one of claims 1 to 12, characterized in that an element generating a suction force is connectable at the outlet of said cavity (3) having a small height.

14. A device according to any one of claims 1 to 13, characterized in that said element generating the suction force is connectable to said flow channel (4) or said opening located on said cavity (3) having a small height.

15. A device according to claim 13 or claim 14, characterized in that said element generating the suction force represents a piston and cylinder unit, and said cylinder receives said separated biological fluid.

16. A device according to any one of claims 1 to 15, characterized in that an element generating a force of pressure is located on said feed chamber (1) and is connectable there.

17. A device according to any one of claims 1 to 16, characterized in that said feed chamber (1) is occluded with a cover (11) in which an opening (12) is formed.

18. A device according to claim 16 or claim 17, characterized in that an element generating a force of pressure is connectable to said opening (12).

19. A device according to claims 15 to 18, characterized in that an element generating a force of pressure is a piston and cylinder unit.

20. A device according to any one of claims 1 to 19, characterized in that the height of said cavity (3) having a small height is smaller than 1 mm.

21. A device according to claim 20, characterized in that said cavity (3) having a small height has a height in the range between 0.01 and 0.5 mm.

22. A device according to any one of claims 1 to 21, characterized in that capillary channels are formed in said cavity (3) having a small height, which are running into said flow channel (4) or said opening.

23. A device according to any one of claims 1 to 22, characterized in that said feed chamber (1) is formed in a cap portion (7) which is connected to an adhesive film (8) in which said cavity (3) is formed, with a base portion (9) in which said flow channel (4) or said opening are formed.

24. A device according to any one of claims 1 to 23, characterized in that said cavity (3) is occluded in a fluid-tight manner apart from within the area of said feed chamber (1) and an opening or in the area of said opening (6) of said transport membrane (5).

25. A device according to any one of claims 1 to 24, characterized in that an intermediate container (14) for separated fluid is connected to said cavity (3) having a small height.

26. A device according to any one of claims 1 to 25, characterized in that said intermediate container (14) is located between said opening, said flow channel (4) and said cavity (3) having a small height.

27. A device according to claim 25 or claim 26, characterized in that an opening for the removal of separated fluid from said intermediate container (14) is occluded with a cover (13).

28. A device according to claim 27, characterized in that said cover (14) is made of a fluid-tight material.

29. A device according to claim 27 or claim 28, characterized in that said cover (14) is permeable to gas.

30. A method for separating undissolved constituents out of biological fluids, characterized in that
said biological fluid is placed into said feed chamber (1);
is passed in the orthogonal direction through said membrane (2) separating said biological fluid from undissolved constituents;
from said membrane (2) into said cavity (3) having a small height;
by means of suction force, force of pressure, capillary forces and/or the hydrostatic pressure of the liquid column; and
is transferred therefrom as a pure fluid into a volume.

31. A method for separating undissolved constituents out of biological fluids, characterized in that
said biological fluid is placed into said feed chamber (1);
is passed in the orthogonal direction through said membrane (2) separating said biological fluid from undissolved constituents;
from said membrane (2) into said transport membrane (5) located within a cavity (3) having a small height wherein the effect of capillary force of which is greater than that of said membrane (2);
by means of suction force, force of pressure, capillary forces and/or the hydrostatic pressure of the liquid column; and
is transferred from said transport membrane (5) as a pure fluid into a volume by means of suction force, force of pressure, capillary forces and/or the hydrostatic pressure of the liquid column.

32. A method for separating undissolved constituents out of biological fluids, characterized in that
said biological fluid is placed into said feed chamber (1);
is passed from said feed chamber (1) into said transport membrane (5) separating undissolved constituents; and
is transversely transferred as a pure fluid by capillary forces of said transport membrane (5) through said cavity (3) having a small height into a volume.

33. A method according to any one of claims 30 to 32, characterized in that the transport and the separation of said biological fluid is supported by forces of pressure acting upon said biological fluid placed into said feed chamber (1).

34. A method according to any one of claims 30 to 33, characterized in that said force of pressure is exerted across an opening (12) which is formed in said cap (11) occluding said feed chamber (1).

35. A method according to any one of claims 30 to 34, characterized in that said forces of pressure are generated with a piston and cylinder unit.

36. A method according to any one of claims 30 to 35, characterized in that with said transport membrane (5) located within said cavity (3) auxiliary separation of undissolved constituents out of said fluid is carried out in addition to the transport.

37. A method according to any one of claims 30 to 36, characterized in that said biological fluid is separated in a suction force supported manner by means of an element generating suction forces, is passed from said membrane (2) into said cavity (3) or said transport membrane (5), is transported to said flow channel (4) or said opening, and said separated biological fluid is received into a volume.

38. A method according to claim 37, characterized in that said suction forces are generated with a piston and cylinder unit, and said separated biological fluid is received within said cylinder of said piston and cylinder unit.
